(19) United States
(12) Patent Application Publication
(10) Pub. No.: US 2026/0368566 A1
(43) Pub. Date: Nov. 19, 2026

(54) AUTOMATED MACHINE LEARNING MODEL INTERPRETABILITY AND ANALYSIS

(71) Applicant: PAYPAL, INC., San Jose, CA (US)

(72) Inventors: Vishal Kumar Singh, Howrah (IN); Padmapriya Mohankumar, Chennai (IN); Ashraf Kamal, New Delhi (IN)

(21) Appl. No.: 19/209,039

(22) Filed: May 15, 2025

(51) Int. Cl. G06N 5/045; G06F 9/50

(52) U.S. Cl. CPC G06N 5/045; G06F 9/5038

(57) ABSTRACT

A method for analyze a model file includes receiving a model file from a user device, determining a model type based on the model file, configuring one or more execution environments for the model file based on the model type, selecting one or more interpretability tasks based on the model type, scheduling the one or more interpretability tasks for execution on the one or more execution environments, executing the one or more interpretability tasks to generate interpretability metrics for the model file, generating a visual representation of at least some of the interpretability metrics, and providing the visual representation to the user device for display on the user device.

### TECHNICAL FIELD

The present disclosure relates to machine learning models and, more particularly, to automated systems and methods for model interpretability and analysis.

### BACKGROUND

Machine learning (ML) models are typically trained on large datasets and then packaged into files that can be deployed in various applications, such as web services, mobile apps, or embedded systems. The process of packaging a model into a file may involve serializing the architecture, weights, and other relevant data of the model into a format that can be easily stored, transmitted, and loaded into memory. This allows the model to be used in a variety of contexts, without requiring the original training data or the specific software environment in which it was trained.

The file formats used to package machine learning models can vary depending on the type of model, the framework used to train it, and the intended deployment environment. For example, TensorFlow models are often packaged in the SavedModel format, while PyTorch models are typically packaged in the TorchScript format. Other formats, such as ONNX and HDF5, are also widely used.

When a model is packaged into a file, the model can be deployed in various applications, such as cloud-based services, mobile apps, embedded systems, and web services. This enables the model to be used to make predictions on new input data, without requiring the original training data or the specific software environment in which it was trained.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of an example model analysis system, in accordance with one or more embodiments.

FIG. 2 is a block diagram of an example process performed by the system of FIG. 1, in accordance with one or more embodiments.

FIG. 3 is a block diagram of an example orchestration process for model analysis, in accordance with one or more embodiments.

FIG. 4 is a block diagram of example interpretability tasks for model analysis, in accordance with one or more embodiments.

FIG. 5 is a block diagram of example visualization process for model analysis, in accordance with one or more embodiments.

FIG. 6 is a flow diagram of an example process for model analysis, in accordance with one or more embodiments.

FIG. 7 is a block diagram of an example computing system, in accordance with one or more embodiments.

### DETAILED DESCRIPTION

As ML models such as deep neural networks, transformers, and large language models (LLMs) become increasingly sophisticated, their internal decision-making processes become more opaque. This black-box nature raises certain challenge in domains such as finance, healthcare, legal systems, and public services, where understanding, trust, and regulatory compliance are routine considerations. Without interpretable insights into how predictions are made by ML models, institutions risk non-compliance with legal standards, suffer from reduced transparency, and may lose stakeholder trust. For example, in banking, opaque credit scoring models may inadvertently propagate bias, while in healthcare, doctors may be reluctant to rely on model predictions they cannot understand, potentially leading to life-threatening errors.

Current interpretability solutions offer only partial solutions by estimating feature importance or providing local approximations of model behavior. However, these tools are limited in scope, not scalable across diverse model types and tasks, and fail to provide causally sound or semantically rich insights. They also lack real-time interactivity, do not adapt dynamically to user feedback, and are insufficient for diagnosing internal model structures or modifying model knowledge. These shortcomings underscore the need for a comprehensive, systematized, and modular interpretability framework that can be utilized across different black-box model types and deployment contexts.

To address these limitations, the present disclosure describes end-to-end, model-agnostic automated interpretability systems and methods. These systems and methods comprehensively analyze, explain, and interact with a black-box machine learning model through a layered and modular architecture. They also integrate multiple interpretability techniques (e.g., model distillation, neuron probing, circuit-based tracing, causal graph construction, and knowledge editing) into a unified framework that can dynamically adapt to the model’s structure, task, and domain.

The systems and methods support an end-to-end lifecycle of interpretability from identifying the model architecture and task, executing the model in secure environments, testing behavioral and performance metrics, to applying a suite of interpretability tools that provide global and local insights. These include interpretable mimic models trained via distillation, subgraph isolations that explain internal circuitry, causal tracing for counterfactual reasoning, and neuron probing to analyze semantic encoding. An integrated visualization and user interface layer supports interactive explanation refinement, counterfactual scenario generation, and fairness assessment across demographics.

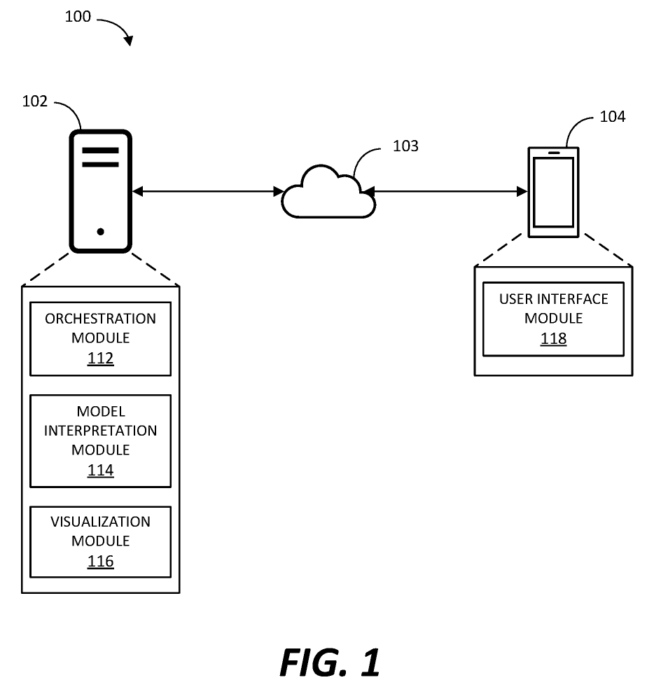

Referring now to the drawings, wherein like numerals refer to the same or similar features in the various figures, FIG. 1 is a block diagram of an example model analysis system 100, in accordance with one or more embodiments. Not all of the depicted components may be used in all embodiments, and one or more embodiments may include additional, fewer, or different components than those shown in the figure. Variations in the arrangement and type of components may be made without departing from the spirit or scope of the claims as set forth herein. Furthermore, the modules described with respect to the model analysis system 100 are used for convenience to refer to functionality that the model analysis system 100 is configured to perform by way of one or more components of the model analysis system 100 (e.g., computer-readable instructions in memory).

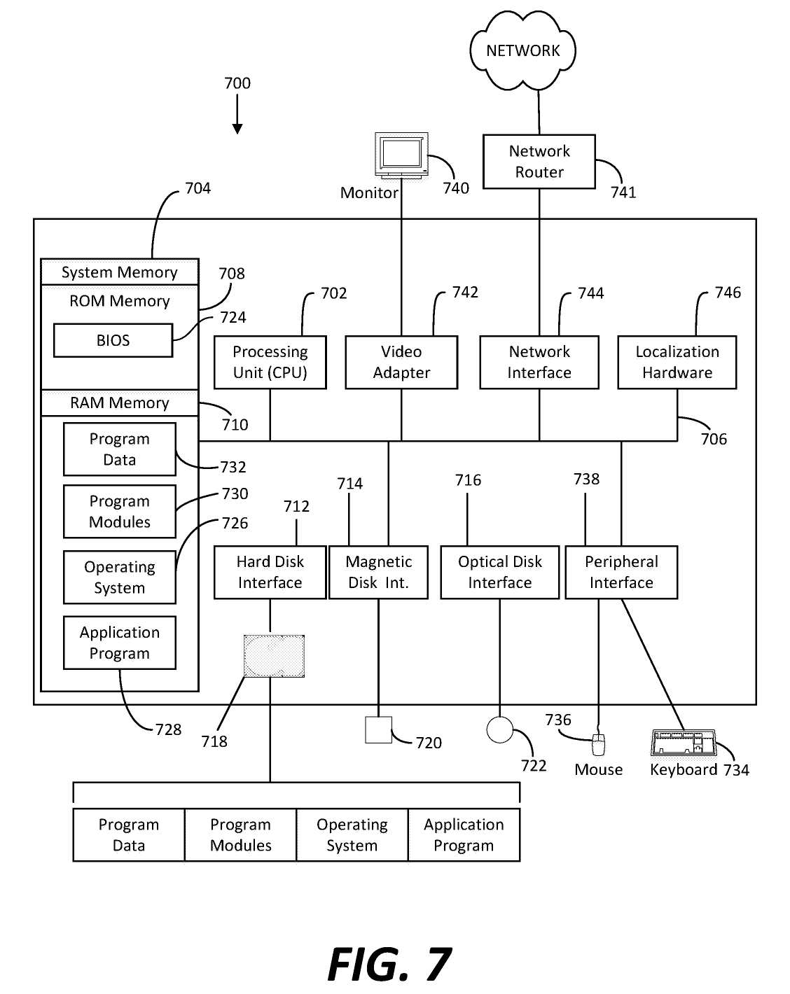

The model analysis system 100 may include a user device 104 associated with a user. The user device 104 may be a computing device such as a laptop computer, desktop computer, tablet, smartphone, smartwatch, or any other electronic device, such as a device having some or all of the components described below with respect to FIG. 7. The user device 104 may include a user interface module (UI module 118), which enables the user to interact with the user device 104. The user can use the UI module 118 to provide data (e.g., credentials) to the user device 104, initiate an interpretability session with the interpretability device 102, modify an interpretability session, and/or any other input. The UI module 118 may be in any suitable format such as a web interface, mobile application, software application, or other software, firmware, or other computer instructions.

The model analysis system 100 may also include an interpretability device 102, which may be a desktop or laptop computer, server, tablet, array/cluster of servers, or any other suitable device or set of devices, such as a device having some or all of the components described below with respect to FIG. 7. The interpretability device 102 may include an orchestration module 112, model interpretation module 114, and visualization module 116.

The orchestration module 112 is configured to orchestrate the flow of operations between model identification, interpretability task execution, and visualization generation. The orchestration module 112 may include control logic that ensures each stage of analysis is executed in the proper order, with appropriate inputs and configurations, and dynamically adapts based on the characteristics of the model being analyzed. The orchestration process may begin with model ingestion, where the user uploads a model file from the user device 104 via the UI module 118. Upon receiving the model, the orchestration module 112 may initiate a model architecture identification operation. This operation may include parsing the model file (e.g., TensorFlow .h5, PyTorch .pt, or ONNX formats) and extracting structural details such as layers, layer types, connections, activation functions, and parameters.

The orchestration module 112 may also initiate a task identification operation, which examines characteristics of the model like the output layer’s activation function, the loss function used during training (if available), and metadata descriptors. This operation helps the orchestration module 112 infer whether the model is performing classification, regression, sequence generation, summarization, or another task. For example, a model ending in a softmax layer with a categorical cross-entropy loss may be inferred as a multi-class classification model, possibly for image or text categorization.

With the model’s architecture and task, the orchestration module 112 may also generate a workflow pipeline tailored to the model type and task, using tools like Apache Airflow to define directed acyclic graphs (DAGs). The DAGs may represent the order and dependencies of downstream interpretability operations, such as distillation, neuron probing, or causal tracing. For example, if the task is text classification and the model is a transformer, the orchestration module 112 may initiate a distillation task that mimics the model using a simpler attention-based model, followed by neuron probing to discover task-specific encodings in the hidden layers.

The orchestration module 112 may also manage the feedback loop and system adaptability. For example, the orchestration module 112 may collect signals from the UI module 118, such as user requests to view specific types of visualizations or provide feedback on explanation clarity, and redirect system attention accordingly (e.g., rerunning neuron analysis with new constraints or re-generating counterfactuals for alternative inputs).

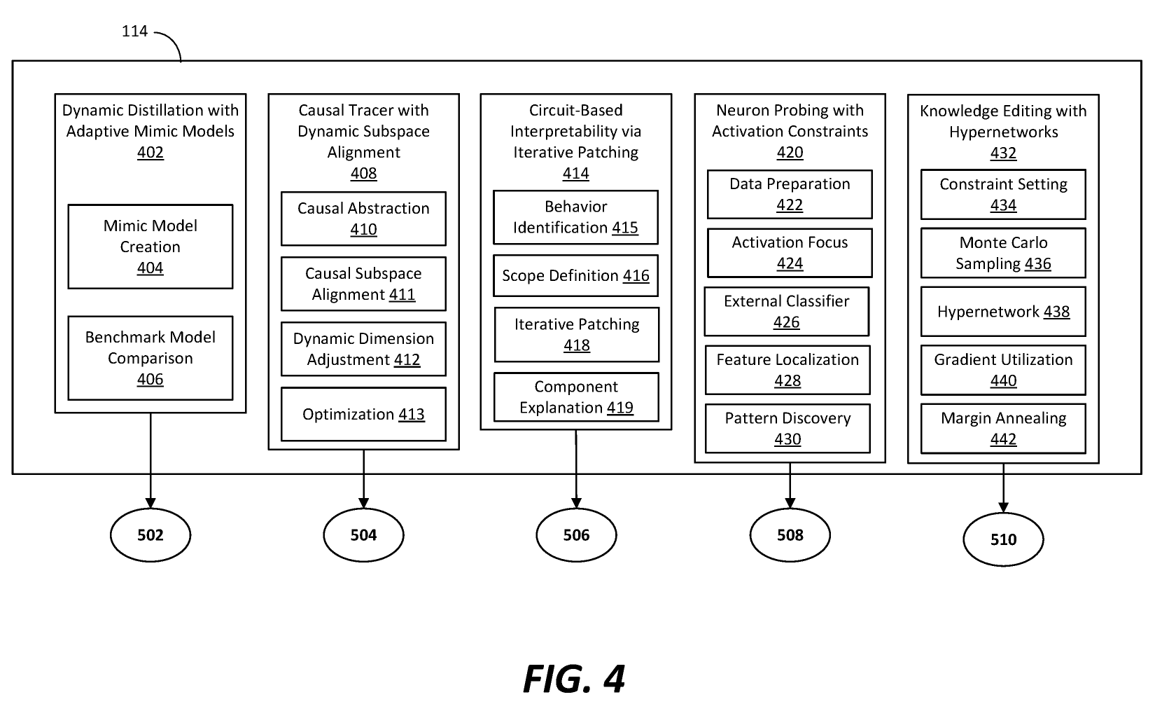

The model interpretation module 114 may execute interpretability tasks orchestrated by the orchestration module 112. The interpretability tasks may determine and/or generate output regarding how the model makes decisions, identify which components within the model contribute to specific outputs, and provide detailed explanations that can be consumed by the user or further visualized through the visualization module 116. The interpretability tasks may include model distillation, neuron probing, iterative patching, causal tracing, knowledge editing, as well as other interpretability tasks described in detail below with respect to FIG. 4. Each interpretability task of the module 114 may be conducted in coordination, triggered and sequenced by the orchestration module 112, and may result in output such as structured representations, metrics, intermediary artifacts (e.g., causal graphs, neuron maps, and simplified models), and/or any other analytics. The module 114 may pass the output from the interpretability tasks to the visualization module 116 for rendering, enabling users to explore the internal reasoning of the black-box model in a transparent and interactive way.

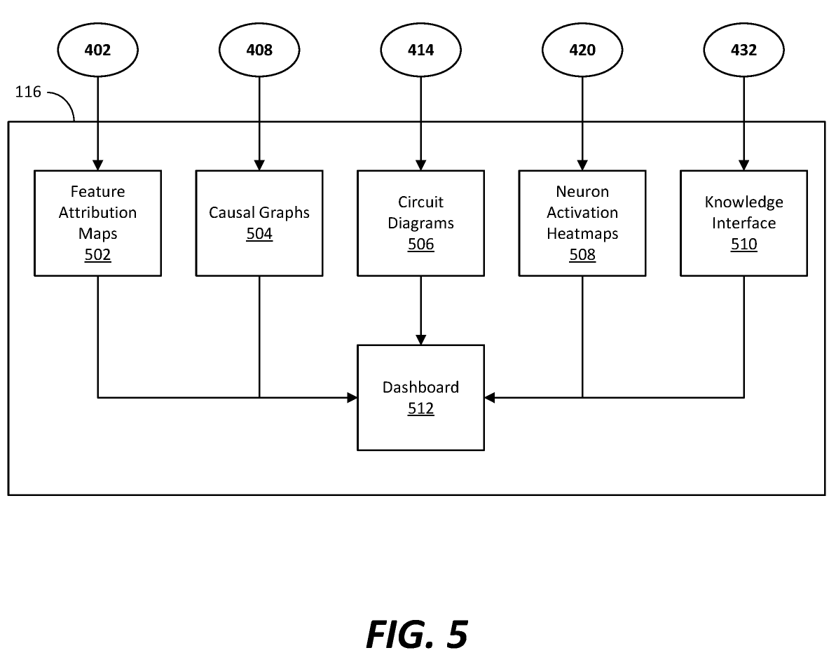

The visualization module 116 may transform the analytical outputs of the interpretation module 114 into visual elements that enable the user to understand and explore the inner workings of the black-box model. The visualization module 116 may generate one or more layers of visualizations, each of which may be tailored to represent different dimensions of interpretability such as feature attribution, causal relationships, neural activity, and model behavior across demographics, as well as other visualizations described in detail below with respect to FIG. 5. The visualization module 116 may utilize a variety of visualization tools and frameworks such as Dash, Plotly, and React-based interfaces. The operations of the various modules are outlined in the following figure.

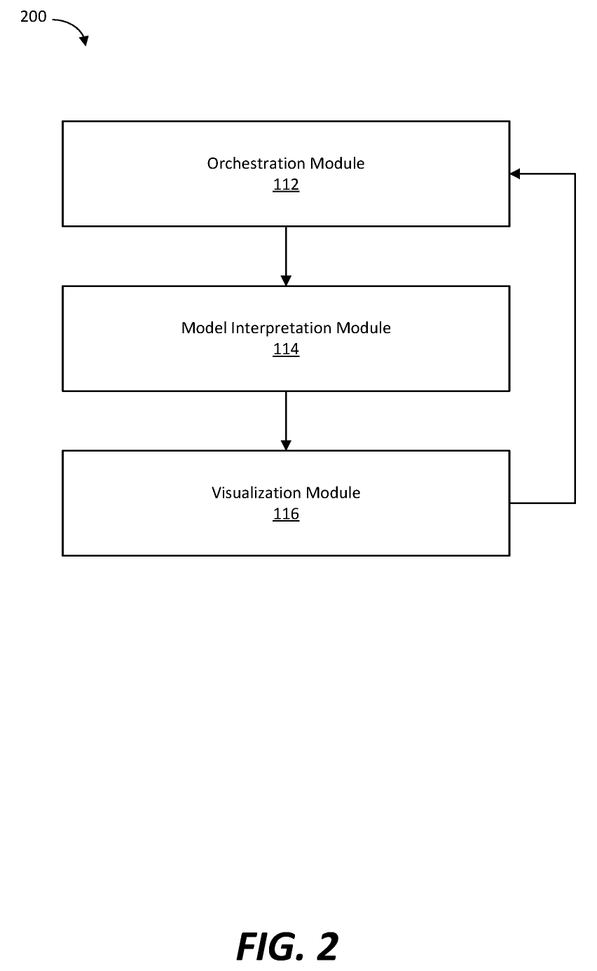

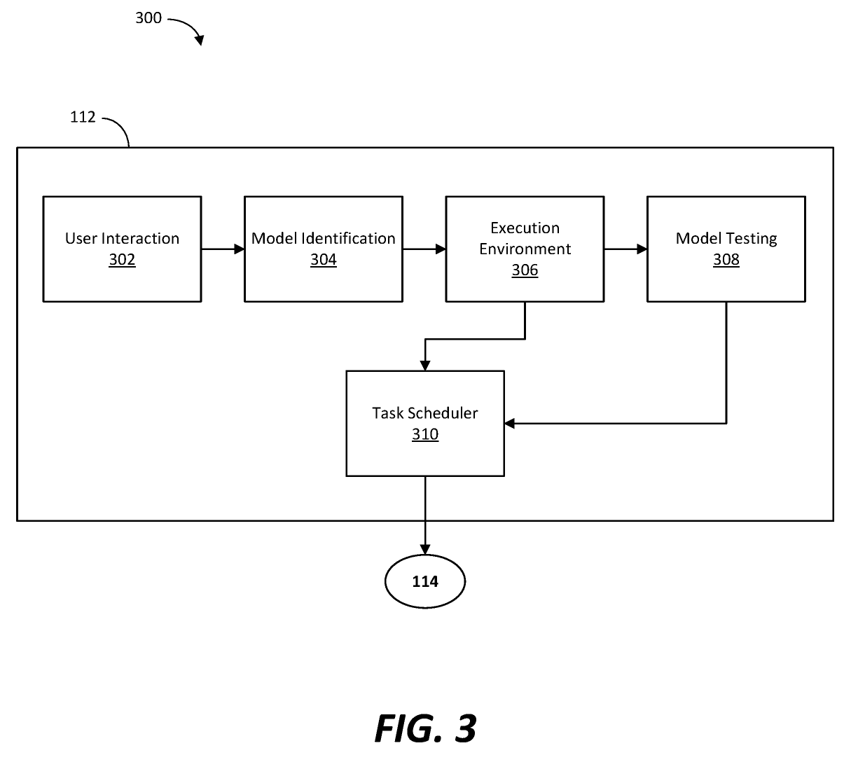

FIG. 2 is a block diagram of an example model analysis process 200 performed by the model analysis system 100, in accordance with one or more embodiments. The process 200 of the automated model analysis may begin with the orchestration module 112, which manages the interpretability workflow. Once a user uploads a model via the UI module 118, the orchestration module 112 may determine the model’s architecture and intended task, such as classification, regression, summarization, or another task. The orchestration module 112 may determine architecture and task by examining the model’s structure, output layers, and/or configuration files. Based on the determined architecture and task, the orchestration module 112 may determine the appropriate sequence of interpretability tasks and dynamically assemble a processing pipeline. Determining the sequence of interpretability tasks and assembling a processing pipeline may include allocating resources, scheduling processes, and routing data between components. The operations performed by the orchestration module 112 are discussed further below with respect to FIG. 3.

Once the orchestration module 112 establishes the workflow, the orchestration module 112 may trigger the model interpretation module 114 to begin the interpretability tasks. The orchestration module 112 may execute one or more interpretability tasks tailored to the specific model architecture and task, such as model distillation, neuron probing, circuit tracing, causal inference, and knowledge editing. The interpretability tasks may reveal how the model arrives at its decisions, what internal components are involved, how inputs influence outputs, and whether any underlying patterns suggest bias, error, or opportunity for optimization. Each interpretability task may output structured artifacts, such as simplified models, activation maps, causal graphs, or explanation scores, which may be passed to the visualization module 116. The operations performed by the orchestration module 112 are discussed further below with respect to FIG. 4.

The outputs of the interpretation module 114 may be input to the visualization module 116, which transforms the outputs into interactive visual elements presentable via the UI module 118 to the user. The visualizations may present complex findings in accessible formats, such as attention maps, fairness dashboards, and counterfactual scenario explorers, which enables the user to understand model behavior. In some embodiments, the model analysis system 100 supports a feedback loop. Based on the visual insights and/or user interactions, new queries or refinements can be routed back to the orchestration module 112. The feedback loop may cause further interpretability tasks to be executed under different configurations of the model or focused on specific areas of interest, enabling iterative exploration and continuous improvement of model transparency. The operations performed by the visualization module 116 are discussed further below with respect to FIG. 5.

FIG. 3 is a block diagram of an example orchestration process 300 for model analysis, in accordance with one or more embodiments. For explanatory purposes, the figure is described with reference to the model analysis system 100 of FIG. 1 and thus the orchestration process 300 may be a computer-implemented method. However, this is merely illustrative, and features of the model analysis system 100 may be performed by any other system for implementing the subject technology. Additionally, for explanatory purposes, the operations of the orchestration process 300 are described herein as occurring sequentially or linearly. However, multiple operations of the orchestration process 300 may occur in parallel. The operations of the orchestration process 300 need not be performed in the order shown, and one or more operations of the orchestration process 300 need not be performed or can be replaced by other operations.

At operation 302, the orchestration module 112 establishes communication with the user device 104. The user may upload a model they wish to analyze through the UI module 118, which may support drag-and-drop uploads or API-based submission. Along with the model file, the user may provide metadata, such as task descriptions, sample input data, configuration preferences, and/or any other relevant data, which the orchestration module 112 may receive and use to tailor the downstream workflow.

The orchestration module 112 may capture the user input and validate it, for example, to confirm that the uploaded model is in a model file format (e.g., .pt, .h5, .onnx). The orchestration module 112 may also check for completeness, for instance, by verifying that any dependencies or auxiliary files required for interpretation (e.g., tokenizers or label mappings) are included. The orchestration module 112 may also perform a compatibility check, for instance, by querying the model’s framework type (e.g., PyTorch or TensorFlow) to determine which backend libraries need to be loaded. A status may be communicated back to the user via the UI module 118, for instance, notifying the user if the upload is successful or prompting the user to correct file format issues.

At operation 304, the orchestration module 112 performs a detailed inspection of the uploaded model to understand its structural and functional properties. The orchestration module 112 may determine the model’s framework (e.g., TensorFlow, PyTorch, ONNX, Scikit-learn) based on file format, file extension, file metadata, configuration files, and/or any other suitable model data. The orchestration module 112 may utilize tools such as ONNX, TorchScript’s graph representation, TensorFlow’s SaveModel, and/or any other suitable tools. The orchestration module 112 may then load the model using the runtime libraries corresponding to the model’s framework.

Once the model is loaded, the orchestration module 112 may inspect the model file and any associated metadata to parse model information, such as layer types, number of parameters, input/output dimensions, and activation functions.

Once the model is parsed, the orchestration module 112 may build a graph-based representation of the architecture. Building the graph-based representation may involve traversing each layer, recording connections and operations, and organizing the connections and operations into a directed graph that visually and logically represents the flow of data through the model. For instance, if the uploaded model is a convolutional neural network, the orchestration module 112 may detect components like Conv2D layers, pooling layers, and fully connected layers, along with their configuration parameters such as kernel size and stride. Based on the structural attributes, the orchestration module 112 may classify the model into a known architectural family, such as transformer, CNN, RNN, or ensemble model.

Additionally, the orchestration module 112 may attempt to determine (e.g., infer) the model task by analyzing output layer characteristics and/or loss functions, if available. For example, the orchestration module 112 may interpret a softmax output layer as a classification task model, while a single-node linear output may be interpreted by the orchestration module 112 as a regression model. If the model includes attention mechanisms and sequence processing layers, the orchestration module 112 may interpret the model as a sequence-to-sequence model for tasks like translation or summarization. In cases where metadata is sparse, the orchestration module 112 may run lightweight diagnostic inferences or prompt the user for clarification via the UI module 118.

Once the architecture identification and/or task identification is complete, the orchestration module 112 may produce a detailed profile of the model’s architecture and task, which may be stored in a standardized, framework-agnostic format (e.g., JSON, YAML). This profile may be used as a basis for selecting and sequencing appropriate interpretability tasks in the following operations.

At operation 306, the orchestration module 112 prepares one or more execution environments in which the model can be executed so that the orchestration module 112 can run the model in the execution environment to verify that the model is functional and produces outputs as expected. The orchestration module 112 may select an appropriate execution environment based on the model’s architecture, task, and/or resource requirements, such as memory size, hardware acceleration (e.g., GPU support), and dependency libraries.

Execution environments may utilize containerization technologies such as Docker to encapsulate the model within a self-contained runtime. The containerized environment enables the rapid construction and destruction of runtime environments as well as isolation, reproducibility, and scalability. The container may include any necessary libraries (e.g., TensorFlow, PyTorch), model-specific configurations (e.g., hyperparameters, batch sizes), and/or environment variables (e.g., memory usage, threading options) for execution.

Once the environment is established, the orchestration module 112 may deploy the model onto the environment. After deployment, the orchestration module 112 may make the model available through APIs (e.g., internal to the interpretability device 102) so that the model can be queried by other modules, such as the interpretation module 114 and/or the visualization module 116. The orchestration module 112 may also expose endpoints to provide inputs to the model, retrieve predictions, and monitor performance metrics in real time.

At operation 308, the orchestration module 112 tests the model to assess the performance of the model. This testing may establish a baseline level of performance and contextualize interpretability results. The orchestration module 112 may start by selecting appropriate benchmark datasets based on the identified task of the model. For instance, a text classification model may be tested on datasets like IMDB, SST-2, AG’s News, and/or Yelp Reviews, while a question answering model might be evaluated using SQuAD, TriviaQA, HotpotQA, and/or RACE.

The orchestration module 112 may load the selected dataset, preprocess the dataset to match the model’s input specifications, and then initiate the tests. Testing may include measuring accuracy, precision, recall, F1-score, AUC, BLEU, and/or any other performance metric based on the task. These metrics may help quantify how well the model performs under typical conditions and serve as a reference point when assessing trade-offs between accuracy and interpretability. For example, if a language model achieves high accuracy on sentiment classification but has poor interpretability scores, the user can decide whether to prioritize transparency over raw performance.

In addition to or instead of performance-based testing, the orchestration module 112 may trigger interpretability-aware testing. This includes applying tools like SHAP (SHapley Additive exPlanations) or LIME (local interpretable model-agnostic explanations) to measure the coherence and consistency of model explanations across the benchmark dataset. The orchestration module 112 may log, visualize, and/or store results of these tests (e.g., for integration into the broader interpretability workflow).

At operation 310, the orchestration module 112 initiates and manages the execution of interpretability tasks based on the information gathered and validated in the previous operations. The orchestration module 112 may use the confirmed architecture, task, and/or performance characteristics of the model to determine which interpretability tasks (e.g., model distillation, neuron probing, causal tracing) are applicable and in what sequence they should be executed based on dependencies and resource allocation for the tasks.

The orchestration module 112 may generate a task graph such as one or more DAGs (directed acyclic graphs) to manage dependencies between interpretability tasks. For example, the orchestration module 112 may schedule neuron probing only after the model has been successfully executed and its activations captured, and the orchestration module 112 may schedule causal tracing after both model predictions and activation maps. The orchestration module 112 may dynamically allocate system resources to runtime environments, balances compute loads across runtime environments, and ensures that each interpretability task receives the inputs it needs in the correct format. The orchestration module 112 may also track task completion and orchestrate iterative workflows if user feedback or unexpected results warrant further analysis. The orchestration module 112 may manage task priorities, retries, and/or failure handling. The orchestration module 112 may also parallelize certain interpretability tasks to improve efficiency, especially when multiple components of interpretability tasks can be run independently. The orchestration module 112 may also consolidate certain interpretability tasks to improve efficiency, especially when a component of an interpretability task is shared across multiple interpretability tasks.

FIG. 4 is a block diagram of example interpretability tasks for model analysis, in accordance with one or more embodiments. For explanatory purposes, the figure is described with reference to the model analysis system 100 of FIG. 1. However, this is merely illustrative, and features of the model analysis system 100 may be performed by any other system for implementing the subject technology.

At task 402, the model interpretation module 114 translates the behavior of the model into a simpler, more interpretable surrogate model, also referred to as a mimic model (404). This distillation process may begin by utilizing the original model as a “teacher” that generates outputs on a predetermined dataset. The interpretation module 114 captures the outputs of the teacher, which may include soft probabilities, logits, or full sequences, depending on the model’s task. The interpretation module 114 utilizes the outputs of the teacher as supervision for training the mimic model, which is chosen to be more transparent, such as a shallow neural network, a decision tree, or a linear model.

For example, if the original model is a deep neural network, the mimic model may be a decision tree or other rule-based model; if the original model is a random forest, the mimic model may be a single decision tree; if the original model is a gradient boosted tree, the mimic model may be a shallow decision tree; if the original model is a support vector machine (SVM), the mimic model may be a linear model; if the original model if a convolutional neural network (CNN), the mimic model may be a local interpretable model-agnostic explanation (LIME); if the original model is a recurrent neural network (RNN), the mimic model may be rule-based sequences; if the original model is an ensemble model (e.g., voting classifiers), the mimic model may be logistic regression; if the original model is a transformer model, the mimic model may be an attention-based model; if the original model is a Bayesian neural network (BNN), the mimic model may be a probabilistic graphical model (PGM).

The architecture of the mimic model may be dynamically selected based on the complexity of the teacher model and/or the identified task. For instance, a large transformer used for document classification may be distilled into a lightweight attention-based RNN or an interpretable generalized additive model (GAM). This adaptive selection enables the mimic model to balance interpretability with predictive alignment, preserving the teacher’s decision patterns while exposing internal logic that can be readily examined. During training, the mimic model may minimize a loss function that measures the discrepancy between its outputs and those of the teacher, such as Kullback-Leibler (KL) divergence for probabilistic tasks or mean squared error for regression-style outputs.

Alongside mimic model training, model interpretation module 114 may also build a benchmark model (406) that is trained on the same or similar dataset but supervised directly by the ground-truth labels, rather than the teacher’s outputs. The benchmark model, which may be a simple classifier like logistic regression or a decision tree, may provide a reference point to evaluate the mimic model’s performance. By comparing how closely the mimic model aligns with the teacher versus how well it captures true task performance, the model interpretation module 114 can measure interpretive fidelity (e.g., the degree to which the mimic model’s predictions match those of the teacher) and/or generalization capacity (e.g., the degree to which the mimic model’s predictions match those of the benchmark model). For example, if the mimic model behaves similarly to the teacher but diverges significantly from the benchmark, it may indicate that the teacher model’s decisions are overfitted or misaligned with ground-truth objectives.

At task 408, the model interpretation module 114 performs causal tracing with dynamic subspace alignment where the model interpretation module 114 analyzes the model’s behavior through causality, translating the model’s internal computations into interpretable causal structures. Causal tracing may include causal abstraction (410), where the module 114 constructs a structural causal model (SCM) that abstracts the functional behavior of the original model, which in this case is a neural network. The SCM may represent the model as a set of causal variables, allowing the system to simulate counterfactuals (e.g., “what if”) scenarios, for instance, by applying interventions and observing how outputs change. These interventions may include modifying input features (e.g., causal variables) or intermediate activations and monitoring their downstream effects on the model’s predictions. For example, in a model used for loan approval, an intervention could simulate the effect of increasing an applicant’s income while keeping other variables constant, offering insights into causal influence.

The module 114 may also perform causal subspace alignment (411), which maps the learned representations of the model (e.g., high-dimensional latent vectors) onto the more interpretable, low-dimensional space of causal variables of the SCM. The module 114 may use orthogonal matrices that transform neural activations into causal subspaces. The module 114 may evaluate how well the neural subspaces align with predefined or learned causal variables using similarity metrics such as cosine similarity and loss-based functions like cross-entropy. The better the alignment, the more confidently the module 114 can interpret a given latent direction in the model as encoding a specific causal relationship. For example, a well-aligned subspace may indicate that a latent vector dimension reliably encodes “education level” as a causal factor in a loan approval prediction task.

An alignment search step further refines the alignment between causal variables and neural subspaces by optimizing the transformation matrix via gradient-based approach (e.g., gradient descent). During the alignment search, the module 114 may iteratively adjust the alignment matrix to minimize the loss (e.g., cross-entropy loss) between the projected neural representations and the causal representations. The output of the alignment search may be an alignment matrix representing the optimal mapping between causal variables and neural subspaces.

The module 114 may then perform dynamic dimension adjustment (412) where the module 114 dynamically adjusts subspace dimensions using boundary index parameters, which define the range of neuron activations that align with causal variables. The dimensional boundaries of the subspace may be fine-tuned using weighted interventions. The interventions may assess how different neural dimensions affect the model’s causal outputs, and the module 114 may adjust the subspace accordingly to improve alignment while ensuring that the core predictive behavior of the model remains intact.

The module 114, in an optimization phase (413), may refine and convert the aligned subspaces into interpretable representations. The module 114 may generate a boundary mask to define which latent neurons participate in a given causal mechanism, and the module 114 may generate a binary mapping matrix to support visualization of these alignments. The matrix helps translate neural activations into human-readable causal diagrams, illustrating, for example, which latent factors drive a specific decision and how changes in those factors causally propagate through the model.

At task 414, the model interpretation module 114 performs circuit-based interpretability via iterative patching. The module 114 dissects the model into smaller, interpretable circuits that reveal how internal components of the model collaborate to produce specific behaviors. The module 114 may identify and track distinct model behaviors (415) that may relate to specific output classes, functional tasks, or latent capabilities within the model, which may include detecting sentiment in a sentence, recognizing a face in an image, or resolving coreferences in a paragraph. The module 114 may place behavioral tracking hooks in the model to observe when and how certain patterns emerge during inference and identify performance metrics (e.g., accuracy, precision) associated to specific behaviors.

Once a target behavior is detected, the module 114 may define the granularity (416) at which it will perform the analysis. This can range from high-level components like attention heads or entire layers, down to individual neurons or multi-layer perceptrons (MLPs). With the scope established, the module 114 may convert the model into a DAG where nodes may represent computational units (e.g., neurons, heads, or layers) and edges may represent information flow.

The module 114 may then perform iterative patching (418), systematically modifying or disabling components in the DAG and observing the resulting changes in model behavior. The patching may involve zeroing out neurons, rerouting connections, perturbing weights, elevating model components, and/or pruning irrelevant nodes. By comparing the model’s outputs before and after each patch, the module 114 may identify which components are more impactful to the observed behavior.

After isolating the relevant subgraph or circuit, the module 114 may formulate hypotheses (419) about the roles of individual components of the model. For instance, the module 114 may hypothesize that a particular neuron is sensitive to vertical edges in image data or that an attention head is tracking pronouns and their antecedents in text data. The module 114 may test the hypotheses through activation analysis (e.g., monitoring how units respond to varied inputs) and/or automated component testing (e.g., gradient-based attribution, correlation with input features, or output sensitivity analysis). The module 114 may measure changes in behavior during the testing and determine whether the changes support or refute each hypothesis by comparing the changes in behavior to the original performance.

The module 114 may synthesize its findings into natural language explanations that describe the function of each circuit component in an interpretable way. For example, the module 114 may determine that “neuron X activates in response to sentiment-laden adjectives,” or that “attention head Y consistently links entity mentions to their references.” These component-level insights provide a functional blueprint of the model’s inner logic, breaking down high-level predictions into traceable, interpretable pathways.

At task 420, the model interpretation module 114 performs hierarchical neuron probing with sparse activation constraints. Neuron probing is an approach to interpret the internal representations of neural networks by training an external classifier on the neuron activations in response to input features. A goal may be to reveal how different features are encoded in the model by inspecting how activations of individual or groups of neurons correlate with labeled properties of the input data. The module 114 may train external classifiers on activation patterns captured from the model’s hidden layers, revealing interpretable relationships between input properties and neuron behavior.

The task 420 may begin with data preparation (422), where the module 114 first tokenizes input text using approaches appropriate to the model architecture, such as WordPiece for BERT or Byte-Pair Encoding for GPT-based models. Alongside the inputs, the module 114 may curate a set of labeled features for the probing classifier to predict. These labels can reflect syntactic features (e.g., part-of-speech tags, grammatical dependencies) or semantic attributes (e.g., named entity categories, sentiment polarity). The module 114 may also allow for the formulation of hypotheses about specific neurons or layers such as “are there neurons that specialize in verb tense?” or “does a certain attention head encode geographical entities?” which guides the focus of the probing process.

At the activation focus stage (424), the module 114 may select the target layers from which neuron activations may be extracted, which may focus on those most likely to contain rich semantic representations. The module 114 may then collect activation for each input in the dataset, capturing the response of individual neurons across different layers. These activation vectors may form the feature space upon which the external classifier operates, which may be the basis for identifying which neurons are responsible for predicting specific labeled features.

In the external classifier probing stage (426), the module 114 may utilize one or more external classifiers (e.g., a linear classifier or shallow multilayer perceptron) that are trained to predict the labeled features from the neuron activations. The simplicity of the classifier ensures that interpretability is focused on the neurons, not on the external classifier.

The module 114 may enforce sparsity constraints, such as limiting the classifier to use no more than k neurons per prediction. This restriction ensures that the resulting interpretations highlight the most relevant neurons and prevent overfitting, promoting simplicity and clarity. The external classifier may be trained using supervised learning techniques (e.g., cross-entropy loss for classification tasks), and hyperparameters like regularization strength or neuron count k are tuned to balance accuracy with interpretability.

In the feature localization stage (428), the module 114 ranks neurons based on their learned importance to the classifier. Ranking neurons may involve analyzing the magnitude of classifier weights, mutual information scores, or neuron-specific performance metrics. The module 114 may also detect broader patterns of specialization, such as certain neurons consistently encoding syntactic roles while others track sentiment shifts.

Finally, in the pattern discovery stage (430), the module 114 may evaluate the external classifier’s predictive accuracy on a test set to determine how well the neurons encode the labeled features. The module 114 may also evaluate sparsity metrics to quantify how few neurons contribute to a prediction. High performance coupled with sparse utilization may suggest that the model has developed internal representations highly specialized for specific tasks.

At task 432, the model interpretation module 114 performs knowledge editing with hypernetworks where the module 114 modifies the model’s internal knowledge. Knowledge editing may be useful for correcting factual errors, updating outdated information, or inserting new knowledge without retraining the entire model. By knowledge editing, the module 114 reconfigures the model’s parameters such that the model’s outputs change for specific target inputs while preserving its behavior on other inputs. The knowledge editing task may be a constrained optimization problem, where an objective is to shift predictions for a designated input-output pair while minimizing unwanted side effects elsewhere in the model’s behavior.

The module 114 may first define the constraints (434) that govern the knowledge editing process. Specifically, the module 114 ensures that the update is localized. That is, the model should produce a different output for the target input (e.g., correcting “Paris is the capital of Italy” to “Rome is the capital of Italy”) but continue to behave identically for non-target inputs. To enforce this stability, the module 114 imposes constraints through regularization over the unchanged dataset, minimizing the shifts in model outputs outside the target input (e.g., by penalizing changes in the model’s outputs for all other inputs). However, evaluating the effect on every possible input is computationally expensive, so the module 114 may utilize Monte Carlo sampling (436) to approximate this constraint. The module 114 randomly selects a subset of non-target inputs at each iteration, ensuring that the approximated constraint holds from the representative set. A subset of non-target inputs is sampled during each training iteration to compute the regularization term.

To implement the editing, the module 114 may utilize a hypernetwork (438), which may include bidirectional LSTM (BiLSTM) and/or feed-forward neural networks (FFNNs). The BiLSTM may capture sequential dependencies in parameter updates, which may be particularly relevant for models with temporal or positional structure (e.g., transformers), while the FFNN predicts specific shifts in parameter values needed to encode the new knowledge. The module 114 may utilize the hypernetwork to predict modifications in the model’s parameters.

The module 114 calculates the gradients (440) of the loss function with respect to the model’s parameters, which helps direct the parameter updates. By using gradient-based optimization techniques like Adam or SGD, the hypernetwork adjusts the model’s parameters. To ensure that the transition is smooth and does not destabilize the model, the module 114 may utilize margin annealing. Margin annealing (442) may start with a large editing margin allowing for bold updates and gradually reduces the editing margin over time, encouraging finer, more precise adjustments as training converges. This progressive tightening of the constraint helps the model smoothly transition to a new knowledge state without sudden behavioral shifts or degradation of previously learned capabilities. The final output is a version of the model that has been edited to reflect new facts or corrections while preserving its overall functionality.

In some embodiments, the module 114 may perform one or more evaluation tasks alongside the interpretability tasks. While interpretability tasks produce qualitative insights (e.g., saliency maps, decision paths, or neuron roles), evaluation tasks may be conducted alongside interpretability tasks to produce quantitative evaluation metrics to help judge the reliability or usefulness of those qualitative insights. Such evaluation metrics may include mimic model mean square error (which quantifies how closely a distilled model approximates the original), mutual information scores (which quantifies how well individual neurons capture interpretable features), and KL-divergence (which quantifies the precision of knowledge edits and/or their localization). The evaluation tasks may be system-wide or task-specific.

Regarding system-wide evaluation tasks, the module 114 may generate fairness metrics representing the impact of model decisions across intersecting demographic groups (e.g., gender and income), measuring both fairness and the trade-off with performance. If disparities are detected, interpretability strategies may be recalibrated to expose or mitigate bias more effectively. The module 114 may also or instead perform benchmarking, comparing the performance and interpretability of different models or explanation techniques on standardized datasets. This comparison enables consistent evaluation across domains and helps refine techniques that underperform in domain-specific scenarios. The module 114 may also or instead perform sensitivity analysis to test how the model and its interpretability tasks react to small perturbations in the input. If an interpretability task’s output dramatically shifts due to minor, irrelevant changes, this may signal instability or overfitting, prompting adjustments to interpretability methods or model architecture. The module 114 may also or instead perform feature importance tracking to examining how feature importance (e.g., attributions) evolve over time or under different data distributions. Feature importance tracking may include monitoring how counterfactual inputs affect feature weightings and detecting inconsistencies that could indicate explanation drift or degraded model fidelity.

Regarding task-specific evaluation tasks, dynamic distillation with adapative mimic models (task 402) may be evaluated through mimic accuracy and/or fidelity analysis. Mimic accuracy includes comparing the mean squared error between the mimic and teacher models as well as ground-truth outcomes. Fidelity analysis includes visualizing and comparing decision boundaries to determine whether the mimic model reflects the decision logic of the black-box model. Hierarchical neuron probing with sparse activation constraints (task 420) may be evaluated through neuron relevance and/or generalization testing. Neuron relevance includes using mutual information to quantify how well individual neurons encode specific features. Generalization testing includes validating that neuron-feature relationships hold on unseen data, helping detect overfitting in the probing classifier. Circuit-based interpretability via iterative patching (task 414) may be evaluated through component functionality testing and/or subgraph minimality testing. Component functionality testing includes perturbing individual components of an isolated circuit to verify their role in decision-making. Subgraph minimality testing includes ablation tests to ensure only the minimal components are retained, improving interpretability. Causal tracer with dynamic subspace alignment (task 408) may be evaluated through causal alignment metrics and intervention tests. Causal alignment metrics include assessing how closely neural subspaces map to causal variables through counterfactual validation. Intervention tests include measuring the reliability of outputs when causal variables are manipulated and refining subspace dimensions if results are below threshold level of performance. Knowledge editing with hypernetworks (task 432) may be evaluated through KL-divergence and/or memory retention. KL-divergence compares model outputs before and after the knowledge update to measure the degree of localized change and ensure that updates do not unintentionally affect unrelated behavior. Memory retention involves testing model performance on original tasks to ensure retention post-edit.

FIG. 5 is a block diagram of example visualizations for model analysis, in accordance with one or more embodiments. The visualization module 116 may be configured to generate visualizations based on the output of the various tasks described above with respect to FIG. 4. The visualizations may include feature attribution maps 502, causal graphs 504, circuit diagrams 506, neuron activation heatmaps 508, and knowledge interfaces 510.

With a feature attribution map 502, the visualization module 116 displays feature attributions for individual predictions and compares feature impacts on predictions between the original and distilled models. The feature attribution map 502 may be used to understand local decision-making processes, offering users a clear view into which words, pixels, or structured input elements were most influential in driving the model’s output.

For local explanations, the visualization module 116 takes the raw feature importance values generated by the model interpretation module 114 and overlays them onto the input. For example, in image classification, the visualization module 116 can highlight regions of the image (e.g., using saliency maps or Grad-CAM) that had the greatest effect on classification, thereby pointing users toward the critical visual cues the model relied on.

To generate a causal graph 504, the visualization module 116 renders graphical representations that depict the cause-and-effect relationships inferred from model’s behavior. The visualization module 116 may generate the causal graph 504 using outputs from the causal tracer (task 408) within the model interpretation module 114, which constructs structural causal models (SCMs) based on the model’s responses to input interventions. The visualization module 116 may translate the SCM into a node-and-edge diagram where nodes represent variables (e.g., input features, latent factors, or output predictions) and directed edges represent causal dependencies or influence paths between them.

Each edge in the causal graph 504 may represent the strength and direction of causal influence, which may be annotated with metrics such as estimated effect size, conditional probabilities, or counterfactual response values. For instance, in a healthcare model predicting patient outcomes, the causal graph might show that “smoking history” has a direct causal influence on “lung function” and an indirect effect on “disease risk” through “inflammation markers.”

With a circuit diagram 506, the visualization module 116 illustrates the internal decision-making pathways of a model by highlighting specific computational circuits responsible for producing certain behaviors. The circuits, identified through the circuit-based interpretability task (414), may include interconnected components such as neurons, attention heads, and network layers that collectively drive particular outputs. The visualization module 116 may translate the isolated subgraph from the model interpretation module 114 into a directed, layered diagram that visually maps the sequence of operations from input to output along the discovered decision path.

Each component in the circuit (e.g., a node in the circuit diagram 506) may be annotated with its functional role or significance, based on the hypotheses and validation tests performed during interpretation. For example, a node might be labeled “neuron X is responsible for detecting vertical edges in images” or “attention head Y focuses on coreference resolution in text,” reflecting insights gathered from hypothesis generation, activation analysis, and/or automated testing. The edges connecting the nodes may indicate information flow and influence, and their thickness or color intensity may denote the strength or criticality of the connection in contributing to the final prediction.

With a neuron activation heatmap 508, the visualization module 116 presents a color-coded matrix that reveals how neurons activate in response to specific inputs, offering a detailed view of the internal representations formed by the model. The visualization module 116 may generate the neuron activation heatmap 508 based on the data produced during neuron probing (task 420). The heatmap 508 may display neurons on one axis and input tokens or features on the other, with color intensity representing the magnitude of activation.

The heatmap 508 may consider mono-semantic and poly-semantic neurons to understand sparse feature representations. Mono-semantic neurons may include those that consistently activate in response to a single, interpretable concept (e.g., dates, names, or emotions) while poly-semantic neurons may include those that respond to multiple unrelated features.

With a knowledge interface 510, the visualization module 116 provides a structured view into how factual knowledge is embedded, modified, and retained within the model. The knowledge interface 510 is driven by outputs from the knowledge editing task 432, which involves selectively updating the model’s parameters to reflect new or corrected information without compromising the overall behavior of the model. The knowledge interface may display the before-and-after effects of knowledge interventions (e.g., fact injection and memory updates). For each edited fact, for example, the knowledge interface 510 may show the specific input (e.g., a query such as “What is the capital of Italy?”), the model’s original output (e.g., “Paris”), and the updated output (“Rome”) after the knowledge edit. The knowledge interface 510 may also trace how the knowledge change was achieved internally, highlighting which layers or neurons were affected during the optimization process. The knowledge interface 510 may include node-link diagrams or parameter heatmaps that mark the regions of the model where adjustments were made.

The visualization module 116 may bring together one or more of the visualizations into a unified dashboard 512. The dashboard 512 may also include interactive feedback visualizations that offer real-time exploration and analysis across different dimensions of interpretability tasks.

One such feedback visualization includes a fairness multi-dimensional analyzer, which displays fairness metrics across dimensions by emphasizing the importance of context, component inclusion, and ongoing monitoring to ensure that fairness in dynamic and complex environments. The fairness multi-dimensional analyzer enables users to dissect model predictions by attributes such as age, gender, income level, or geographic region, showing how fairness performance shifts across these attributes. Interactive elements like sliders, filters, and stratified views help users drill down into the specific sources of bias or disparity.

A hallucination score indicator includes a numeric gauge that measures the likelihood or severity of hallucinations in model outputs, particularly for language generation tasks. The score (e.g., ranging from 0 to 100) may reflect how confidently and accurately the model stays aligned with factual or expected information. When the score is high, users may be alerted to potentially unreliable outputs.

An attention visualization may show attention maps that illuminate how a model distributes its focus across input elements. Users can visualize which tokens or image regions are weighted most heavily in the model’s internal calculations, helping them understand which parts of the input were deemed most influential. For example, in a text classification task, the tool might show that certain emotionally charged words triggered strong attention, revealing the underlying mechanics of the model’s decision-making.

A counterfactual explanation generator lets users explore “what-if” scenarios by modifying input features and observing how these changes affect the model’s predictions. It highlights the minimal set of changes required to flip a prediction, offering insights into decision boundaries and feature sensitivity.

A stratified insight analyzer breaks down interpretability outputs based on context or demographics in real-time or near-real-time. This visual provides a live feedback lens, processing new data entries and delivering digestible insights. This visual simplifies complex patterns by layering explanations according to user-defined or automatically detected strata, helping organizations make sense of model behavior across diverse user groups or scenarios.

A knowledge hierarchy builder visually organizes stored or inferred model knowledge into structured, hierarchical formats such as tree maps or mind maps. This enables users to explore how different pieces of knowledge relate to one another, identify thematic clusters, and trace the logical structure of learned information.

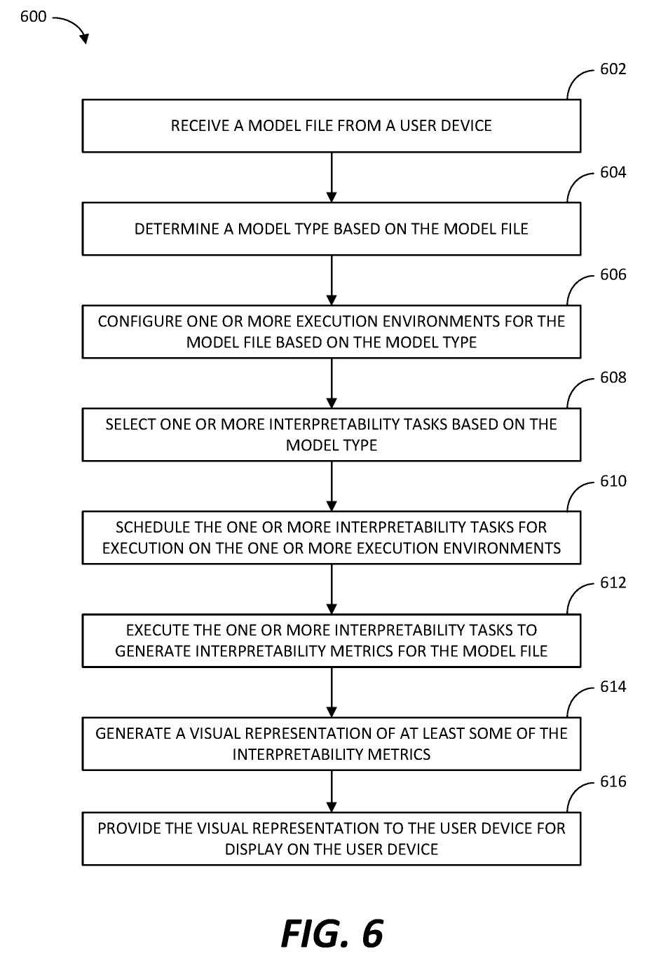

FIG. 6 is a flow diagram of an example process 600 for model analysis, in accordance with one or more embodiments. For explanatory purposes, the figure is described with reference to the model analysis system 100 of FIG. 1 and thus the process 600 may be a computer-implemented method. However, this is merely illustrative, and features of the model analysis system 100 may be performed by any other system for implementing the subject technology. Additionally, for explanatory purposes, the operations of the process 600 are described herein as occurring sequentially or linearly. However, multiple operations of the process 600 may occur in parallel. The operations of the process 600 need not be performed in the order shown, and one or more operations of the process 600 need not be performed or can be replaced by other operations.

At operation 602, the orchestration module 112 receives a model file from the user device 104. The interpretability device 102 may have a communication channel with the user device 104 (e.g., via network 103). The user may interact with the UI module 118 to upload model files. The UI module 118 enable one or more methods of file transfer, including drag-and-drop widgets, file browser selectors, RESTful API endpoints, and/or the like.

At operation 604, the orchestration module 112 determines a model type based on the model file. The model type may include the model’s architecture and/or task. To determine the architecture, the orchestration module 112 may parse the model file using a framework-specific loader, such as torch.load for PyTorch or keras.models.load_model for TensorFlow. The orchestration module 112 may inspect the model’s internal structure, iterating through layers of the model and recording attributes such as layer types (e.g., Conv2D, Dense, LSTM), connectivity patterns, activation functions, and/or parameter counts.

From the parsed structure, the orchestration module 112 may construct a graph-like representation of the model’s architecture. This representation helps classify the model into one of several high-level categories, such as a convolutional neural network (CNN), recurrent neural network (RNN), transformer, ensemble method, or fully connected feedforward network. For example, the presence of convolutional and pooling layers followed by a softmax output layer would indicate a CNN likely designed for image classification, while multiple attention layers and position embeddings might suggest a transformer model for sequence tasks.

The orchestration module 112 may also attempt to infer the model’s task by analyzing the output layer and, where available, the associated loss function. If the output layer uses a softmax activation and the loss function is categorical cross-entropy, the task is likely multi-class classification. If the output layer is a single unit with linear activation and the loss function is mean squared error, the task is likely regression. In the absence of explicit loss function metadata, the orchestration module 112 may simulate an inference pass on dummy data to observe the shape and nature of the output, further informing task inference.

At operation 606, the orchestration module 112 configures one or more execution environments for the model file based on the model type. The execution environments may be isolated runtime environments to support model evaluation and interpretability tasks. The execution environments may be tailored according to the model’s architecture and task, as determined in operation 604, which enables the conditions of the execution of the models to be controlled and reproduceable. Each environment may be implemented using containerization technologies (e.g., Docker), which may encapsulate necessary dependencies, libraries (e.g., PyTorch, TensorFlow), hardware configurations (e.g., resource allocation), and runtime settings for executing the model.

The execution environments may also correspond to the interpretability tasks that will be performed later in process 600. For example, if a transformer-based model has been identified and will undergo neuron probing or attention visualization, the orchestration module 112 may configure an execution environment with additional memory allocation and support for specific debugging tools. Conversely, simpler models destined for global feature attribution might utilize more lightweight environment configurations. In embodiments where multiple interpretability tasks are scheduled in parallel or sequential stages, multiple environments may be configured.

In some embodiments, the orchestration module 112 may also put the model through a set of initial behavioral and/or performance tests within the configured environment. These tests may include basic functional tests, such as verifying input-output flow, checking for inference stability, and running sanity checks on model outputs using sample or synthetic inputs. Additionally, early-stage metrics like prediction accuracy, output range validation, or response latency may be determined to establish a performance baseline. The initial tests may be used to verify that the model is operational and behaving as expected before deeper, task-specific interpretability workflows are launched. In some embodiments, the visualization module 116 may generate and provide one or more visual representations of the initial tests to the user device 104 for display on the user device 104. In some embodiments, the process 600 may proceed to the next operation in response to the model satisfying a threshold performance score; otherwise, the orchestration module 112 may provide an indication of failure to the user device 104 indicating an issue with the model file.

At operation 608, the orchestration module 112 selects one or more interpretability tasks based on the model type. For models categorized as deep neural networks (DNNs), the orchestration module 112 may select tasks, such as hierarchical neuron probing, that enable in-depth inspection of internal neuron activations in response to input features. For models categorized as transformer-based, the orchestration module 112 may select tasks, such as causal tracing, that simulate interventions and trace information flow across the model, revealing which components drive certain decisions and how changes to inputs propagate through latent representations. For models categorized as tree-based models or ensemble learners (e.g., gradient boosted trees or random forests), the orchestration module 112 may select tasks, such as dynamic distillation, that quantify and visualize decision logic between the original and distilled models.

Once selected, the interpretability tasks may be bundled into a workflow and scheduled for execution within the previously configured environments.

At operation 610, the orchestration module 112 schedules the one or more interpretability tasks for execution on the one or more execution environments, accounting for task-specific dependencies, resource availability, and/or execution constraints. Scheduling enables the interpretability tasks to run in the correct order, with access to the inputs, model outputs, and intermediate data each task requires. The orchestration module 112 may manage the scheduling process through a workflow engine, such as Apache Airflow or a custom DAG-based scheduler.

In some embodiments, the orchestration module 112 evaluates dependencies of interpretability tasks and generates a schedule that enforces logical progression so that tasks are not started prematurely or without the necessary prerequisites. For example, neuron probing may require prior activation data from model inference runs, and causal tracing may depend on previously aligned subspace representations. Similarly, dynamic distillation may complete before comparative visualization tasks can be run to evaluate fidelity between the original and mimic models.

In some embodiments, the orchestration module 112 also considers parallelism and resource optimization. Independent interpretability tasks (e.g., feature attribution and fairness analysis) can be executed concurrently in separate environments to reduce latency. The orchestration module 112 may dynamically allocates computational resources, such as memory and I/O bandwidth, based on each task’s complexity and priority. If a task execution fails (e.g., due to resource constraints or unexpected model behavior), the orchestration module 112 can initiate retry mechanisms or fallback procedures, such as model reloading.

At operation 612, the model interpretation module 114 executes the one or more interpretability tasks to generate interpretability metrics for the model file. Some of the possible interpretability tasks are described above with respect to FIG. 4; however, other possible interpretability tasks are contemplated. Once the scheduled tasks are completed, the metrics output from the executed tasks may be passed on to the next operation for visual representation and delivery to the user.

At operation 614, the visualization module 116 generates a visual representation of at least some of the interpretability metrics. The visualization module 116 transforms the structured metrics generated during the previous operation (e.g., neuron activation scores, causal effect estimates, feature attributions, and decision fidelity values) into interactive, graphical representations that make complex model behavior easier to explore and understand. The visualization type and structure are determined based on the nature of the interpretability task and the specific metrics involved. Some of the possible visualizations are described above with respect to FIG. 5; however, other possible visualizations are contemplated.

At operation 616, the interpretability device 102 provides the visual representation to the user device for display on the user device 104. The interpretability device 102 may utilize secure communication protocols (e.g., HTTPS) and standardized data formats (e.g., JSON, SVG, or WebSocket streams for live updates) to transfer the visual data. The UI module 118 may render the visualizations, which may be a browser-based dashboard or a standalone application.

FIG. 7 is a block diagram of an example computing system 700. A computing system 700 may be a desktop computer, laptop, smartphone, tablet, or any other electronic device having the ability to execute instructions, such as those stored within a non-transitory computer-readable medium. Furthermore, while described and illustrated in the context of a single computing system 700, those skilled in the art will also appreciate that the various tasks described hereinafter may be practiced in a distributed environment having multiple computing systems 700 linked via a local- or wide-area network in which the executable instructions may be associated with and/or executed by one or more of multiple computing systems 700.

In its most basic configuration, the computing system 700 may include at least one processing unit 702 and at least one memory 704, which may be linked via a bus 706. Depending on the exact configuration and type of computing system environment, memory 704 may be volatile (such as RAM 710), non-volatile (such as ROM 708, flash memory, etc.) or some combination of the two.

Computing system 700 may have additional features and/or functionality. For example, computing system 700 may also include additional storage (removable and/or non-removable) including, but not limited to, magnetic or optical disks, tape drives and/or flash drives. Such additional memory devices may be made accessible to the computing system 700 by means of, for example, a hard disk drive interface 712, a magnetic disk drive interface 714, and/or an optical disk drive interface 716. As will be understood, these devices, which may be linked to the system bus 706, respectively, allow for reading from and writing to a hard drive 718, reading from or writing to a removable magnetic disk 720, and/or for reading from or writing to a removable optical disk 722, such as a CD/DVD ROM or other optical media. The drive interfaces and their associated computer-readable media may allow for the non-volatile storage of computer-readable instructions, data structures, program modules and other data for the computing system 700. Those skilled in the art will further appreciate that other types of computer-readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer-readable (e.g., computer-implemented) instructions, data structures, program modules or other data. Any such computer storage media may be part of computing system 700.

A number of program modules may be stored in one or more of the memory/media devices. For example, a basic input/output system (BIOS 724), containing the basic routines that help to transfer information between elements within the computing system 700, such as during start-up, may be stored in ROM 708. Similarly, RAM 710, hard drive 718, and/or peripheral memory devices may be used to store computer-executable instructions comprising an operating system 726, one or more applications programs 728, other program modules 730, and/or program data 732. Still further, computer-executable instructions may be downloaded to the computing system 700 as needed, for example, via a network connection. The applications programs 728 may include, for example, orchestration module 112, model interpretation module 114, and visualization module 116.

An end-user may enter commands and information into the computing system 700 through input devices such as a keyboard 734 and/or a pointing device 736. While not illustrated, other input devices may include a microphone, a joystick, a game pad, a scanner, etc. These and other input devices would typically be connected to the processing unit 702 by means of a peripheral interface 738 which, in turn, would be coupled to bus 706. Input devices may be directly or indirectly connected to processing unit 702 via interfaces such as, for example, a parallel port, game port, firewire, or a universal serial bus (USB). To view information from the computing system 700, a monitor 740 or other type of display device may also be connected to bus 706 via an interface, such as via video adapter 742. In addition to the monitor 740, the computing system 700 may also include other peripheral output devices, not shown, such as speakers and printers.

The computing system 700 may also utilize logical connections to one or more computing system environments. Communications between the computing system 700 and the remote computing system environment may be exchanged via a further processing device, such as a network router 741, that is responsible for network routing. Communications with the network router 741 may be performed via a network interface component 744. Thus, within such a networked environment, e.g., the Internet, wide area network (WAN), local area network (LAN), or other like type of wired or wireless network, it will be appreciated that program modules depicted relative to the computing system 700, or portions thereof, may be stored in the memory storage device(s) of the computing system 700.

The computing system 700 may also include localization hardware 746 for determining a location of the computing system 700. In embodiments, the localization hardware 746 may include, for example, a GPS antenna, an RFID chip or reader, a Wi-Fi antenna, or other computing hardware that may be used to capture or transmit signals that may be used to determine the location of the computing system 700.

While this disclosure has described certain embodiments, it is understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system’s registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A method comprising:
receiving a model file from a user device;
determining a model type based on the model file;
configuring one or more execution environments for the model file based on the model type;
selecting one or more interpretability tasks based on the model type;
scheduling the one or more interpretability tasks for execution on the one or more execution environments;
executing the one or more interpretability tasks to generate interpretability metrics for the model file;
generating a visual representation of at least some of the interpretability metrics; and
providing the visual representation to the user device for display on the user device.

2. The method of claim 1, wherein the visual representation is a first visual representation and further comprising:
selecting one or more evaluation tasks based on the model type;
scheduling the one or more evaluation tasks for execution on the one or more execution environments;
executing the one or more evaluation tasks to generate evaluation metrics for the model file;
generating a second visual representation of at least some of the evaluation metrics; and
providing the second visual representation to the user device for display on the user device.

3. The method of claim 1, wherein the model type includes a model architecture and a model task.

4. The method of claim 3, wherein determining the model type comprises:
determining the model architecture by parsing layers in the model file; and
inferring the model task based on a loss function and output layer of the model file.

5. The method of claim 1, wherein each of the one or more execution environments corresponds to each of the one or more interpretability tasks.

6. The method of claim 1, wherein:
the model type is associated with a deep neural network and the one or more interpretability tasks includes neuron probing;
the model type is associated with a transformer model and the one or more interpretability tasks includes causal tracing; and
the model type is associated with a tree-based model and the one or more interpretability tasks includes dynamic distillation.

7. The method of claim 1, wherein the execution of the one or more interpretability tasks is scheduled based on dependencies of at least one of the one or more interpretability tasks.

8. The method of claim 1, wherein execution of at least one of the one or more interpretability tasks is scheduled to be in parallel with the execution of at least one other interpretability task.

9. A computing device comprising:
an orchestration module configured to perform operations comprising:
determining a model type based on a model file;
configuring one or more execution environments for the model file based on the model type;
selecting a first interpretability task and a second interpretability task, wherein the selection is based on the model type; and
scheduling the first interpretability task and the second interpretability task for execution on the one or more execution environments, wherein the second interpretability task is dependent on the first interpretability task and the second interpretability task is scheduled for execution after the first interpretability task;
a model interpretation module configured to perform operations comprising:
executing the first interpretability task to generate a first interpretability metric for the model file; and
executing the second interpretability task to generate a second interpretability metric for the model file; and
a visualization module configured to perform operations comprising:
causing a user interface to display on a user device for receiving the model file;
generating a visual representation of at least one of the first or second interpretability metrics; and
causing the user interface to present the visual representation on the user device.

10. The computing device of claim 9, wherein:
the visual representation is a first visual representation;
the orchestration module is configured to perform operations further comprising:
selecting a third interpretability task and a fourth interpretability task based on the model type; and
scheduling the third interpretability task for execution on the one or more execution environments before the fourth interpretability task, wherein the fourth interpretability task is dependent on the third interpretability task;
the model interpretation module is configured to perform operations further comprising:
executing the third interpretability task to generate a third interpretability metric for the model file; and
executing the fourth interpretability task to generate a fourth interpretability metric for the model file; and
the visualization module is configured to perform operations further comprising:
generating a second visual representation of at least one of the third or fourth interpretability metrics; and
providing the second visual representation to the user device for display on the user device with the first visual representation.

11. The computing device of claim 9, wherein determining the model type comprises parsing layers in the model file to determine a model architecture.

12. The computing device of claim 11, wherein:
the model architecture is a deep neural network and the first interpretability task includes neuron probing;
the model architecture is a transformer model and the first interpretability task includes causal tracing; and
the model architecture is a tree-based model and the first interpretability tasks includes dynamic distillation.

13. The computing device of claim 9, wherein determining the model type comprises identifying an output layer of the model file to infer the model task.

14. The computing device of claim 9, wherein the one or more execution environments corresponds includes a first execution environment associated with the first interpretability task and a second execution environment associated with the second interpretability task.

15. The computing device of claim 9, wherein:
the visual representation is a first visual representation;
the orchestration module is configured to perform operations further comprising:
selecting a first evaluation task associated with the first interpretability task and a second evaluation associated with the second interpretability task, wherein the first evaluation task is selected based on the model type and the second evaluation task is selected based on the second interpretability task; and
scheduling the first evaluation task and the second evaluation task for execution on the one or more execution environments;
the model interpretation module is configured to perform operations further comprising:
executing the first evaluation task to generate a first evaluation metric for the model file; and
executing the second evaluation task to generate a second evaluation metric for the model file; and
the visualization module is configured to perform operations further comprising:
generating a second visual representation of at least some of the first and second evaluation metrics; and
providing the second visual representation to the user device for display on the user device.

16. A method comprising:
determining a model type based on a model file received from a user device;
configuring an execution environment for the model file based on the model type;
executing, on the execution environment, a first evaluation task to generate a performance score; and
in response to the performance score satisfying a threshold performance score:
selecting a plurality of interpretability tasks based on the model type;
scheduling an order of the plurality of interpretability tasks for execution on the execution environment;
executing the plurality of interpretability tasks to generate interpretability metrics for the model file, wherein the executing occurs in the scheduled order;
generating a visual representation of at least some of the interpretability metrics; and
providing the visual representation to the user device for display on the user device.

17. The method of claim 16, further comprising, in response to the performance score satisfying the threshold performance score:
selecting a plurality of evaluation tasks based on the plurality of interpretability tasks;
scheduling the plurality of evaluation tasks for execution on the execution environment;
executing the plurality of evaluation tasks to generate a plurality of evaluation metrics;
generating another visual representation of at least some of the evaluation metrics; and
providing the other visual representation to the user device for display on the user device with the visual representation of the at least some of the interpretability metrics.

18. The method of claim 16, further comprising, in response to the performance score not satisfying the threshold performance score:
providing an indication of failure to the user device.

19. The method of claim 16, wherein selecting the plurality of interpretability tasks is further based on the performance score.

20. The method of claim 16, wherein execution of the plurality of interpretability tasks is scheduled based on dependencies of at least one of the plurality of interpretability tasks.
